(19) United States
(12) Patent Application Publication
(10) Pub. No.: US 2005/0182654 A1
(43) Pub. Date: Aug. 18, 2005

(54) Systems and methods for providing treatment planning

(75) Inventors: Amir Abolfathi, Woodside, CA (US); Todd Iketani, Redwood, CA (US); Henry Chan, Dublin, CA (US); Samuel Kass, Santa Clara, CA (US)

Correspondence Address: ALIGN TECHNOLOGY, INC.;ATTENTION: SCOTT SMITH, 881 MARTIN AVENUE, SANTA CLARA, CA, 95050, US

(73) Assignee: ALIGN TECHNOLOGY, INC., Santa Clara, CA (US)

(21) Appl. No.: 10/779,079

(22) Filed: Feb. 14, 2004

(51) Int. Cl. G06F 17/60

(52) U.S. Cl. 705/2

(57) ABSTRACT

A virtual health-care community is disclosed. The community includes a network to communicate information relating to the community; one or more treatment consultants coupled to the network; one or more treating professionals coupled to the network; and a server coupled to the network, the server storing data for each patient and facilitating secured data sharing by the community.

### BACKGROUND

The present invention relates to systems and methods for treatment planning.

The Internet has become a significant medium for communication and commerce and has enabled millions of people to share information and conduct business electronically. The unique characteristics of the Internet, such as its ability to provide enhanced communication, rich text, and graphic environment, provide an ideal support for a wide variety of electronic commerce transactions.

The ubiquity and convenience of the Internet makes it ideal for dispensing information on certain topics that traditionally require visits to specialists. For example, certain consumers may be interested in products and services associated with orthodontics and dentofacial orthopedics that specializes in the diagnosis, prevention and treatment of dental and facial irregularities (“malocclusion” or “bad bite”). Orthodontic treatment can improve dental health and change facial appearance for the better, and it can boost self-esteem. It can provide the patient with the chance to participate in improving the way he or she looks. Patients often feel more self-confident even before treatment is completed. The orthodontic treatment process typically uses corrective appliances such as braces and/or other fixed or removable appliances to bring the teeth, lips and jaws into proper alignment and to achieve a facial balance. For example, the Invisalign® system commercialized by the assignee of the instant invention, Align Technology of Santa Clara, Calif., is a clear removable appliance that can correct teeth malocclusion. Invisalign® products were designed to be distributed to orthodontists and dentists for their use with patients. Orthodontists and dentists may analyze and prescribe orthodontic treatment for their patients using the Invisalign® product.

Even though state regulators allow specialists such as orthodontists and non-specialists such as dentists to provide orthodontic care, orthodontic treatments have traditionally been provided by orthodontists. As specialists, orthodontists generally complete two or three years of advanced training after graduating from college and dental school. However, advances in computer and orthodontic technology have reduced some of the barriers to the practice of orthodontics. As a result, an increasing number of non-specialists are offering orthodontic services. However, in certain cases, non-specialists may need to consult with specialists to ensure the best treatment outcome for the patients.

### SUMMARY OF THE INVENTION

In one aspect, a virtual health-care community is disclosed. The community includes a network to communicate information relating to the community; one or more treatment consultants coupled to the network; one or more treating professionals coupled to the network; and a server coupled to the network, the server storing data for each patient and facilitating secured data sharing by the community.

In another aspect, a server to support a health-care electronic commerce community with one or more service providers includes a processor adapted to communicate with a network; a data storage device coupled to the processor and adapted to store data for each patient; and software to communicate 3D patient data from a first service provider to a second service provider.

Advantages of the invention may include one or more of the following. The system allows generalists (for example new dental professionals) who are not intimately familiar with specialist practices (orthodontics, for example) to provide quality orthodontic care for their patients. Web technology is used as a medium in which the general dentists can gather necessary patient case information and electronically pass the information to a consultant or specialist for diagnosis and treatment planning, therefore, allowing general dentists to provide high quality of care to their patients. The system serves both the doctors seeking expertise and the expertise providers, as well as the associated scanners and administrators. The system serves the doctor at the beginning of the case submission process, when a less experienced doctor seeking to perform orthodontic treatment needs help before diagnosing precise malocclusion and prescribing a solution. The system generates data that can be sent to a dental fabricator such as Align Technology, Inc. as the first step in a case submission. The system allows the doctor seeking expertise to log in, track cases, choose providers, maintain their contact information, and submit new cases and associated case information. The expertise providers will be able to log in, maintain their contact information, track and view case information, and submit diagnoses and prescriptions. Scanners will be able to log in, and submit associated information concerning a case.

In addition, the ability to directly upload orthodontic images and forms to a web system allows doctors and consultants to quickly respond to one another. The ability to immediately share such information improves the efficiency of the orthodontic consultation process.

### BRIEF DESCRIPTION OF THE DRAWINGS

FIG. 1 illustrates one embodiment of a system for collaboratively treatment.

FIG. 2 illustrates one exemplary system for delivering prescription and treatment forms to a doctor/customer from a consultant.

FIG. 3 shows an exemplary messaging system to allow interactive communication between a treating professional and a consultant.

FIG. 4 shows one embodiment of a system for providing online orthodontic prescription forms.

FIG. 5 shows an exemplary system for displaying and uploading dental images.

FIG. 6 shows an exemplary state diagram for the system of FIG. 1.

FIGS. 7-11 shows various exemplary user interfaces for the system of FIG. 1.

### DESCRIPTION

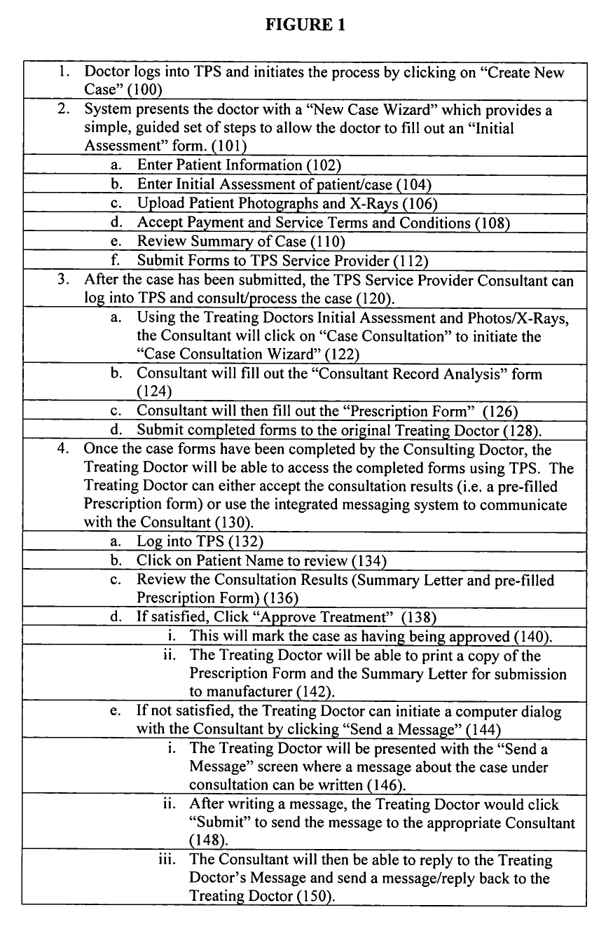

FIG. 1 illustrates one embodiment of a system for collaboratively filling out dental/orthodontic prescription and treatment forms. In this embodiment, a Doctor logs into TPS and initiates the process by clicking on “Create New Case” (100). Next, the system presents the doctor with a “New Case Wizard” which provides a simple, guided set of steps to allow the doctor to fill out an “Initial Assessment” form (101). The doctor may enter Patient Information (102), enter Initial Assessment of patient/case (104), upload Patient Photographs and X-Rays (106), accept Payment and Service Terms and Conditions (108), review Summary of Case (110), or submit Forms to a consultant such as a Treatment Planning System (TPS) Service Provider (112). After the case has been submitted, the TPS Service Provider Consultant can log into TPS and consult/process the case (120). Using the Treating Doctors Initial Assessment and Photos/X-Rays, the Consultant will click on “Case Consultation” to initiate the “Case Consultation Wizard” (122). The consultant can fill out the “Consultant Record Analysis” form (124). The consultant can also complete the “Prescription Form” (126) and submit completed forms to the original Treating Doctor (128). Once the case forms have been completed by the Consulting Doctor, the Treating Doctor can access the completed forms using TPS. The Treating Doctor can either accept the consultation results (i.e. a pre-filled Prescription form) or use the integrated messaging system to communicate with the Consultant (130). The Treating Doctor can log into TPS (132), click on Patient Name to review (134), review the Consultation Results (Summary Letter and pre-filled Prescription Form) (136). If satisfied, the Treating Doctor can click “Approve Treatment” (138), and this will mark the case as having being approved (140). The Treating Doctor will be able to print a copy of the Prescription Form and the Summary Letter for submission to manufacturer (142). Alternatively, if not satisfied, the Treating Doctor can initiate a computer dialog with the Consultant by clicking “Send a Message” (144). The Treating Doctor will be presented with the “Send a Message” screen where a message about the case under consultation can be written (146). After writing a message, the Treating Doctor would click “Submit” to send the message to the appropriate Consultant (148). The Consultant will then be able to reply to the Treating Doctor's Message and send a message/reply back to the Treating Doctor (150).

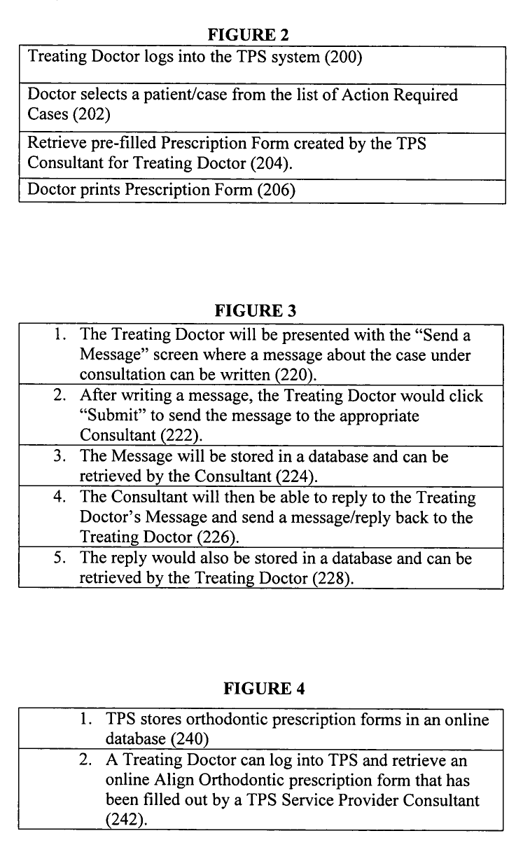

FIG. 2 illustrates one exemplary system for delivering completed orthodontic prescription and treatment forms to a doctor/customer from a consultant. In this embodiment, the Treating Doctor logs into the TPS system (200). The Doctor selects a patient/case from the list of Action Required Cases and clicks on the link (202). The pre-filled Prescription Form created by the TPS Service Provider Consultant for that case is retrieved from a database and presented to the Treating Doctor (204). The Doctor can then print the Prescription Form (206).

FIG. 3 shows an exemplary messaging system to allow interactive communication between a doctor and a consultant providing orthodontic consultation services. In this exemplary process, the Treating Doctor will be presented with the “Send a Message” screen where a message about the case under consultation can be written (220). After writing a message, the Treating Doctor would click “Submit” to send the message to the appropriate Consultant (222). The Message will be stored in a database and can be retrieved by the Consultant (224). The Consultant will then be able to reply to the Treating Doctor's Message and send a message/reply back to the Treating Doctor (226). The reply would also be stored in a database and can be retrieved by the Treating Doctor (228). Operations 222-228 are repeated until the messaging dialog is complete.

FIG. 4 shows one embodiment of a system for providing online orthodontic prescription forms. In this embodiment, TPS stores orthodontic prescription forms in an online database (240). A Treating Doctor can log into TPS and retrieve an online Align Orthodontic prescription form that has been filled out by a TPS Service Provider Consultant (242).

In an exemplary system for displaying and uploading dental images, a Treating Doctor will be presented with an “Upload Images” page that will allow the doctor to select an Orthodontic Image type. The Doctor will be able to browse a list of files and identify an appropriate image to be uploaded. The operations are repeated until all images are identified. After the Doctor has identified all images, the “Upload Images” button is clicked. This initiates a file upload process and associates the images with the currently active case/patient. These images may be retrieved by a TPS Service Provider Consultant and used to prepare an orthodontic prescription for the patient.

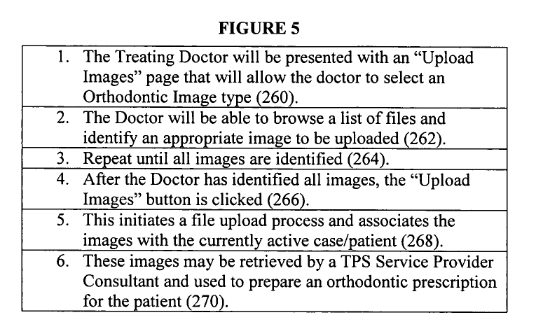

FIG. 5 shows an exemplary process for uploading data to the system. The Treating Doctor will be presented with an “Upload Images” page that will allow the doctor to select an Orthodontic Image type (260). e Doctor will be able to browse a list of files and identify an appropriate image to be uploaded (262). The foregoing operations are repeated until all images are identified (264). After the Doctor has identified all images, the “Upload Images” button is clicked (266). This initiates a file upload process and associates the images with the currently active case/patient (268). These images may be retrieve by a TPS Service Provider Consultant and used to prepare an orthodontic prescription for the patient (270).

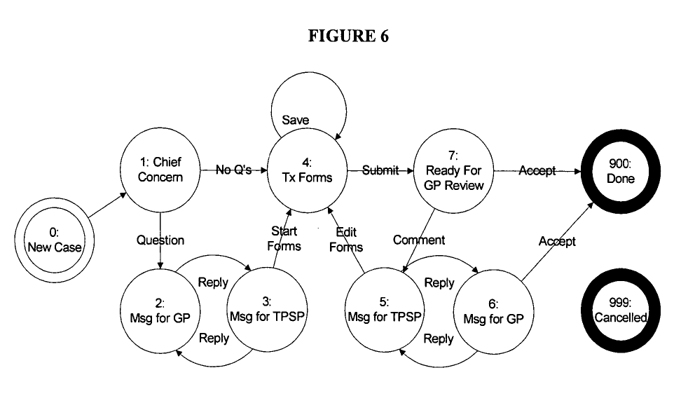

FIG. 6 shows an exemplary state diagram for one TPS embodiment. In this state diagram, each case can be in one state at a time, which reflects who needs to work on it and what needs to be done. For example, if a case is in state 2 and the GP logs in, the UI should reflect the fact that there is a message awaiting their reply. There are no arrows to canceled because every state can go to cancelled. Once a case is cancelled it has to be re-submitted as another new case if the process is to be re-started. A case should progress through the state transition table until it is complete or cancelled. A case starts at state 0 when it is first created, and remains in state 0 until the initial concern form is completed. When that form is completed, it enters state 1. At that time, the TPS provider (TPSP) has action required (review the form), and the GP does not. When the TPSP begins filling out their forms, it enters state 4. At state 4 the TPSP still has the action required, in that there is a partially filled form that has not yet been submitted. When the TPSP completes the form, the case enters state 7, “Ready for GP Review”. At that time, the GP has action required (review the forms), and the TPSP does not. When the GP accepts the forms, the case goes to 900, done. In between state 1 and 4, and in between state 4 and 7, there are states that represent messages being sent back and forth. State 2 and state 6 represent a message waiting for the GP, and thus action is required on the GP side (read the message and reply.) States 3 and 5 represent a message waiting for the TPSP, and thus action is required on the TPSP side (read the message and either reply or finish the diagnosis and prescription form.)

In one embodiment, the Treatment Planning Service is a set of servlets, JSP pages, database tables, and file system areas creating a system by which providers of orthodontic expertise can assist the less experienced in the diagnosis and prescription of orthodontic treatment.

The first page the user sees is the TPS intro page, which welcomes them to the site and offers a link to enter the site. Clicking the login link should load the login page. There is an additional link that refers to a tutorial, and when this link is clicked, a PDF tutorial is downloaded to the doctor's computer that contains instructions on how to use the site. The login page contains two edit fields for the user name and password. The password letters should not be displayed, but be replaced by dots. Entering the user name and password and clicking the “Login” button or hitting return should allow the user to proceed to a main page depending on their account type. In addition to these fields, the login page contains a link to click if one has forgotten their password, or if they are a new user. If the forgotten password link is clicked, a page appears that allows the user to enter their user name. When the user clicks ok, e-mail should be sent to them at the e-mail address they registered during new user registration containing their password. If the username entered does not exist in the system, an error page will be displayed, with a “Back” and a “Home” button—the former of which returns to the forgotten password page, and the latter back to the login page. If the id is in the system but does not have an e-mail address, a page is displayed that advises them to call a support telephone number, and has a button to return them to the login page. If the new user registration link is clicked, the site should progress to the New User Registration section. If the username and password combination is not valid, a page is displayed that informs the user of this. Pressing “Ok” from this page returns them to the front page.

The doctor cast list has four major sections. The first is the banner at the top of the page. It should contain a logo based on the default TPS provider chosen by the doctor. On the left are the commands available. For the doctor case list, the command can be “Start New Case”. On the center/right are the cases that the doctor has submitted that have not been cancelled, split into two categories. “Action Required” and “No Action Required”. Cases appearing in action required for the doctor are cases that either do not have a Chief Concern form, have a message waiting for the GP, or have a completed treatment waiting for the GP. Cases with no action required are cases for which the Chief Concern has been filled out but are awaiting a Diagnosis and Prescription form, cases for which replies to messages have been sent, and completed cases. Clicking on the patient's name in either list should bring the doctor to the case data page for that case. The case data page is composed of four sections. At the top remains the logo of the default TPS Provider. At the left is the list of actions, in the right middle are the vital statistics of the patient, and at the bottom is a 4-pane region containing detailed case data. The action pane on the left should have appropriate actions enabled, and inappropriate actions grayed out and disabled. The appropriate actions are dependent on the state of the case. Approve Treatment is available in states 5, 6, and 7, and brings to to the Approve Treatment page. Change Consultant is available until the TPSP begins the forms in state 4, and leads to a page that allows the user to change TPSP. Message Consultant is available in states 2, 6, and 7, and puts a message in the Comments section of the case. Edit Initial Assessment is available in state 0 and brings the doctor back to the New Case wizard. Cancel This Case is available in all states except Done or Cancelled, and cancels the case (which can still have billing repercussions.) The final option, Home, is always available, and returns the doctor to the case list.

The vital statistics area contains the case #, patient name, status, sex, TPSP, age, date of birth, and a link to the images for the case. The 4-pane information region allows the doctor to review comments (messages), the initial assessment form, the treatment summary, and the prescription form. Clicking on a tab should switch to that form or page. All the forms should be disabled, with no control able to be modified, and have no way to submit changes. If the selected form is not available, the message “Form not available.” should appear instead of content. If Approve Treatment is clicked, the next page is a confirmation on whether the doctor really would like to approve the treatment plan. If the doctor approves the treatment, a confirmation page appears offers a link allowing the doctor to print out all the forms for submission to Align Technology, Inc. A button at the lower right allows the doctor to return to the case list. The Change Consultant screen allows the doctor to change the TPSP for a given case. The screen displays the same patient vital information, but in the content area allows the doctor to either select the preferred provider, or search for another provider. The preferred provider appears as “Option 1”, with the bio in a text box below it, and the name of the provider linked to the provider profile. “Option 2” brings the doctor to a list of TPSPs, each one's name linked to its provider profile, with a radio button allowing the doctor to select one of them instead of the primary provider. The provider profile page contains the bio, payment terms, indemnity agreement, and office address information. A “Back” button allows the doctor to return to the TPSP selection screen. The Message a case screen is the same as the case info screen, except the 5-pane is replaced with a text box that allows the doctor to type a message to the TPSP that appears in the comments section of the case. There are buttons for “Cancel” or “Submit”. When the GP chooses to cancel a case, a reason should be specified.

When a provider logs into the system, the first screen that is displayed is the case list. The case list for the provider is simpler than that of the doctor. There are no commands available. The logo at the top is that of the TPS provider that is logged in. There is a list of cases split into to categories: action required, and no action required. Cases that have action required are ones for which either a message is waiting, or a chief concern form is ready to be treated. All other cases appear in the No Action Required list. The names of the cases in the list are linked to the case data page for that case. The case data page is divided into four areas. Across the top of the page is a banner with the logo of the currently logged-in TPSP. On the left are the available commands. In the top center are the vital statistics for the currently selected case, and below that is a 5-pane tabbed box with further details and forms.

The commands available depend on what state the case is in. Case Consultation is available at any time except after a case has been completed. Assign case is available at any time except when a case has already been completed. Message Treating Doctor is available in stages 1, 3, or 5. The vital statistics area contains the case #, patient name, status, sex, TPSP, age, date of birth, and a link to the images for the case. The 5-pane information region allows the doctor to review comments (messages), all the forms, and the treatment summary. Clicking on a tab should switch to that form or page. All the forms should be disabled, with no control able to be modified, and have no way to submit changes. If the selected form is not available, the message “Form not available.” should appear instead of content.

The treat case command enables the TPSP to fill out the diagnosis and prescription forms, review the case, and submit them to the GP for review. While these forms are being filled out, the images are available from a link in the patient's vital statistics area by clicking on the “View” link. The consultant assessment form is an evaluation of the patient's current condition in the estimation of the orthodontic expert, given the photographs and initial assessment from the GP. The prescription form should match the Align online prescription form in content. It is intended to be submitted to Align Technology, Inc. to initiate production of appropriate aligners. One the consultant assessment and prescription forms have been filled out, the treat case wizard should allow the TPSP to review the forms and the summary generated from them. There is a “Back” button that allows the TPSP to go back and change something, a “Cancel” button that discards changes and returns to the case data page, and a “Submit” button that submits the forms for review by the GP.

If the Submit button is pressed, a confirmation screen will appear. Assigning a case is the action of attaching a descriptive string to the case intended to identify the party that is to fill out the diagnosis and prescription forms. When the TPSP clicks on the “Assign Case” button a text area should appear allowing the TPSP to enter a string (length<=31 characters.) Clicking “Submit” assigns the case, which should then appear in the case list next to the case. Pressing “Cancel” should return to the case data page. Sending a message to the GP allows the TPSP to type text that appears in the “Comments” section of the case, and sets the case state so that the GP will see a message waiting for them. When the TPSP clicks “Message to GP”, a large text area should appear that allows the user to type several lines of text (length should allow at least 2K of text.) There is also a checkbox that will append “Please call me at <TPSP phone #>” to the message. Clicking Submit submits the message and changes the state, while “Cancel” returns to the case data page.

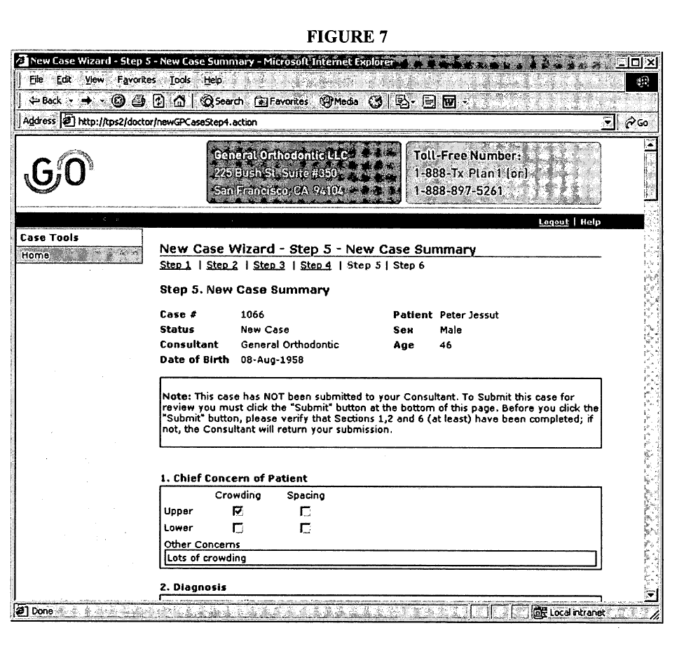

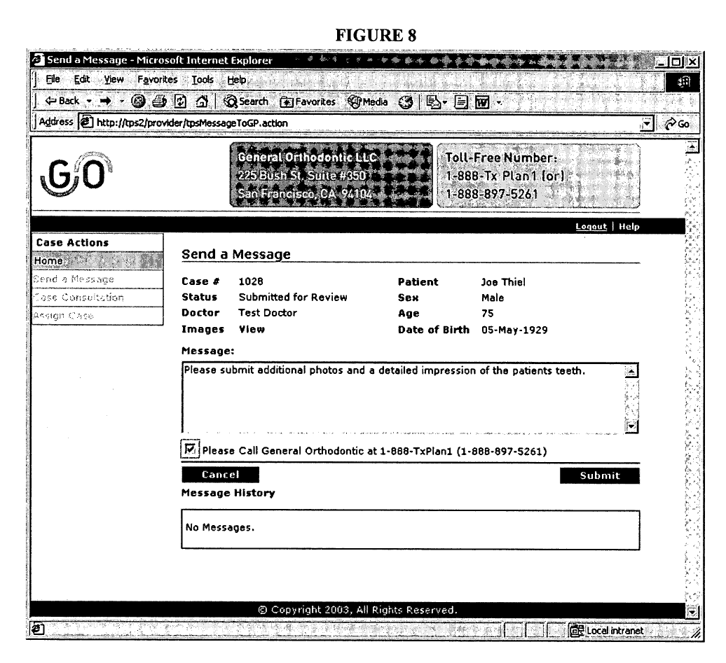

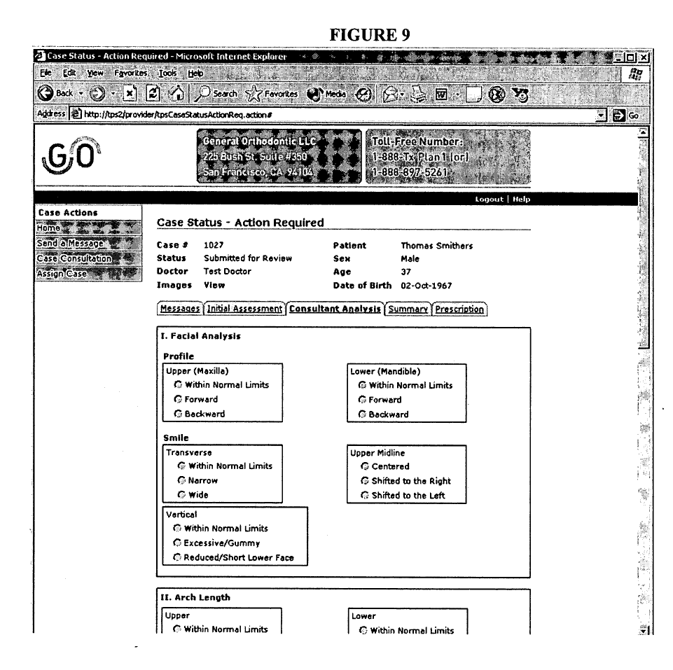

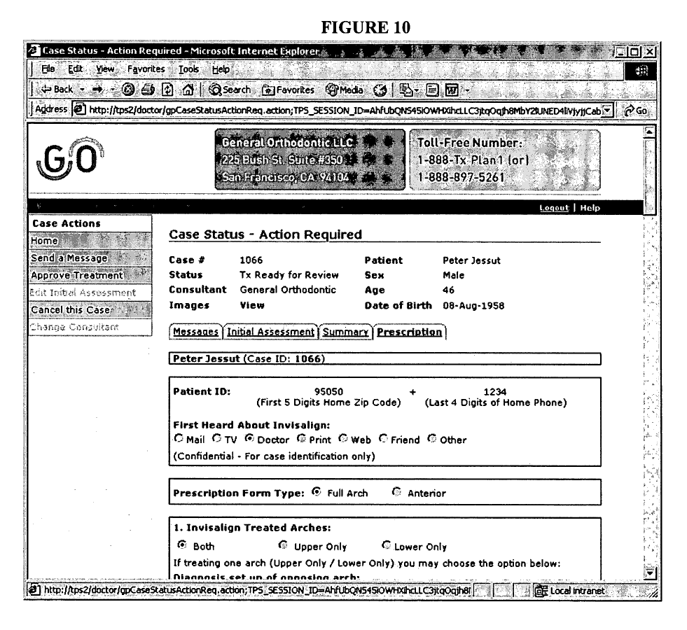

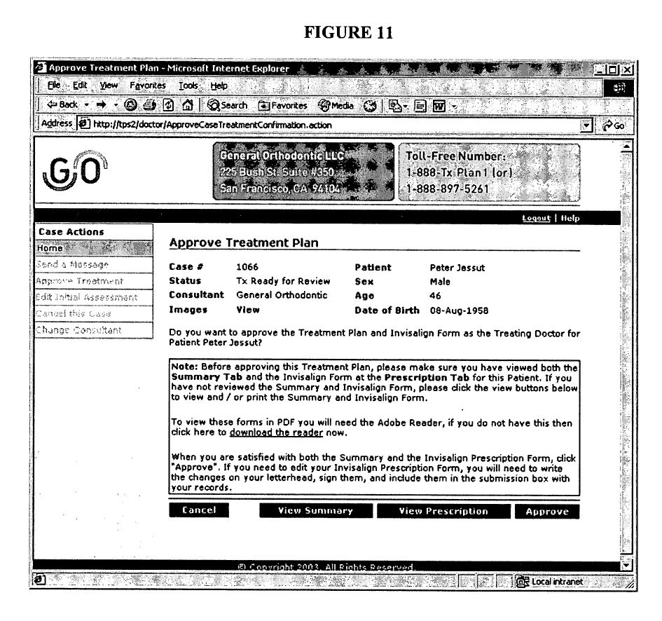

FIG. 7 is an exemplary screen shot illustrating State 1 where doctors enter their Chief Concerns. FIG. 8 is an exemplary user interface for States 2,3,5,6 that show messaging between a consultant and a doctor. FIG. 9 is an exemplary user interface for State 4 where the consultant fills out analysis, Summary, and Prescription form. FIG. 10 is an exemplary user interface for State 7 showing a doctor's review of treatment plan. The doctor can approve it, or send a message to the consultant for further refinement. FIG. 11 shows an exemplary user interface where the doctor approves treatment, which is then ready to submit to a dental fabrication company such as Align Technology, Inc.

An environment supporting a collaborative system of FIG. 1 is discussed next. The system communicates over a network that can be a local area network or a wide area network such as the Internet. One or more client computers can be connected to the network. In one embodiment where the network is the Internet, the client computers execute a suitable browser such as Navigator® from Netscape, Inc. or Internet Explorer® from Microsoft Corp. By clicking on the highlighted text (or specific graphic image), the user can jump from the current web page to a new web page address associated with the link—with the new page displayed on the screen. In this manner, the user can “surf the web” by clicking on an almost endless succession of links going to page after page all following a common thread as defined by the text or graphic component of the link label. Through the network, the client computers can access a health server, for example a dental server that houses dental information. The dental server serves a web site, a portal, a vortal (vertical portal), or a content site for providing dental-related information to interested parties such as dental patients, dentists, orthodontists, and others. When sensitive information is communicated through the dental server, such information may be securely encrypted using Secure Socket Layer (“SSL”) technology throughout the transaction. The server can be a stand-alone computer or can be a server farm that can distribute processing and communication activity across a computer network so that no single device is overwhelmed. During load balancing, if one server is swamped with requests, excess requests are forwarded to another server with more capacity. The network connects the dental server to one or more treating professional workstations. The workstations allow treating professionals access to a plethora of services provided by the dental server such as patient treatment and office management, among others. The dental server stores information associated with patient history on-line in a secure manner and also provides the treating professional a comprehensive view of the patient's treatment history at any time using a suitable browser, eliminating the need to pull treatment files or charts or to search for misfiled or lost charts. The dental server also provides treating professionals with tools to analyze patient data, for example, tools to reconstruct a 3D model or rendering of the patient's teeth. For example, using the browser, the treating professional can request the dental server to animate the progress of the treatment plan. When the treating professional arrives at a prescription or other final designation or diagnosis, the treatment prescription is used to automatically generate appliances, as described in more detail below. Further, in addition to aiding treating professionals in treating patients, the software allows the treating professional to perform office management, purchasing and other logistical operations using the browser and the dental server.

In addition to communicating with patients and treating professionals, the dental server can communicate with one or more partners using the network. The partners can be TPS service providers, product suppliers, service providers, or any suitable commercial entities. For example, one partner can be a financing partner that offers customers one or more electronic financing options. In one implementation, the financing partner can be a credit card processing company. The credit card processing company can accept a customer's existing credit card or can issue the customer with a new credit card. Further, the credit card can be issued under the name of a third-party bank, the name of the credit card processing company, or the name of the site supported by the dental server under a co-branding arrangement.

In one embodiment, the consulting professional is paid using credit card. In this case, the treating professional enters sensitive data such as credit card number, shipping address, among others, onto a purchase form. The credit data is then submitted, collected and passed securely through the dental server using SSL. This data can be processed in real-time online or can be collected by mail or telephone and then entered by an operator. A processor at the credit card processing company then verifies that the credit card number is valid and is not stolen, among other anti-fraud measures. If the credit card information is valid, the purchase price will be reserved from the issuing bank of the consumer's credit card and allocated to the account associated with the server. Periodically, the credit card processor settles all accounts; it is at this time that all monies move. Funds reserved are transmitted from the issuing bank of the cardholder's credit card to the account of the server. Also, discount fees are paid from these funds, as they are moving.

Alternatively, the financing partner can debit from the customer's checking account over the Internet. One such check debiting services is the MerchanTrust™ Paperless Checks™ Services, available from Merchant Commerce, Inc. These services provide customers with the convenience of making online purchases by checking account debits, with no manual data entry required of a merchant. In this embodiment, a customer fills in a form at the site with bank information printed at the bottom of his or her personal check. The information is processed as an Electronic Funds Transfer (EFT) to the customer's account using the Automated Clearinghouse (ACH) payment system.

Yet another possible partner is a dental supply retailer providing an on-line shop on the web site to retail dental products to the dental professionals. The retailer can be a co-branding partner that uses the brand name linked or suitably associated with the web site of the server such that users of the server would not know that the on-line shop is actually operated by a third party. The retailer can offer dental products for brushing, flossing, and cleaning of dental implants and bridges. Other dental products include anti-plaque rinse and plaque-fighting toothpaste. The retailer can also sell other health-care-related products such as prescription drugs; non-prescription drugs; personal care products; beauty and spa products; vitamins; herbs and nutrition; and medical supplies. Additionally, the retailer can serve the needs of the treating professionals by offering products such as brackets, buccal tubes, bands, archwire products, bonding adhesives, hand instruments, systems, supplies and equipment.

The above list of partners lists only exemplary partners and is not an exhaustive list. Other possible partners include value-added service providers such as third party software providers who provide plug-in viewing and diagnostic enhancements that can be used by the professionals.

In combination, the dental server forms a hub that links dental consultants and treating professionals using workstations and partners into a living electronic commerce (e-commerce) community.

An exemplary usage of the system of FIG. 1 from a treating professional's perspective. A prospective patient uses a client computer and visits the web site on the dental server. The client identifies a treating professional and schedules an appointment with the treating professional. Alternatively, a referring dentist can refer the client to the treating professional. The referring dentist can visit the website on the dental server and uses one or more dental esthetic tools to show patients the potential benefits of treatment, e.g., anterior and posterior esthetic restorations, and if the patient is interested, refers the patient to the treating professional.

During an initial examination, the treating professional or an assistant may take, e.g., a set of digital facial and intraoral images which is uploaded to a secure, collaborative workspace on the dental server 106. The workspace is shared with the referring dentist. Next, the treating professional generates a dentofacial treatment visualization showing the patient's face and smile before and after treatment. The treating professional can also combine the patient's face and an aligner into the intraoral image to show how inconspicuous the appliance will be.

Once the patient requests treatment, the treating professional takes impressions and a bite registration and sends the information to the company. The treating professional may also capture other data, such as by taking a lateral ceph and a panorex, and upload them to the company and/or workspace and/or website. The treating professional may also generate or create a treating prescription or plan and upload the same to the company and/or website and/or to the workspace. At any time, the treating professional may review the treatment plan and adjust or approve the same. The professional can also invite a TPS consultant such as an orthodontist to review the images. The consultant may make various modifications to the treatment plan and discuss with the treating professional in accordance with the process of FIG. 1. Once a treatment plan is accepted, appliances such as aligners may then be accordingly fabricated as described below.

At a fabrication company such as Align Technology, Inc., a technician reviews the records and decides to accept or decline the case. If accepted, the models are scanned, and the intraoral images are retrieved and used to texture-map enamel and gingiva. The data is then sent to the company and/or workspace and/or website and the treating professional is notified.

In one embodiment, the tooth models may be posted on a hypertext transfer protocol (http) web site for limited access by the corresponding patients and treating clinicians. Since realistic models have a large volume of data, the storage and transmission of the models can be expensive and time-consuming. To reduce transmission problems arising from the large size of the 3D model, in one embodiment, data associated with the model is compressed. The compression is done by modeling the teeth meshes as a curve network before transmission to the treating professional or website. Once the curve network is received, the 3D model is reconstructed from the curve network for the treating professional to analyze. More information on the compression is disclosed in a co-pending application having Ser. No. 09/506,419, entitled, “EFFICIENT DATA REPRESENTATION OF TEETH MODEL”, and filed by ELENA PAVLOVSKAIA and HUAFENG WEN on Feb. 17, 2000, the contents of which are hereby incorporated by reference in their entirety.

The treating professional can, at his or her convenience, check the setup, and review the received information. The treating professionals can use a variety of tools to interpret patient information. For example, the treating professional can retrieve and analyze patient information through a reconstructed 3D model of the patient's teeth and other anatomical structures. The professional can view animations showing the progress of the treatment plan to help the treating physician visualize the pace of treatment. Using these tools, the treating professional can easily and quickly view and/or edit the treatment plan.

If necessary, the treating professional can adjust one or more teeth positions at various intermediate stages of treatment. A variety of diagnostic decision-support capabilities such as automated teeth collision detection can be used to aid the treating professional in adjusting the teeth positions.

When the treating professional arrives at a prescription or other final designation, the treatment information is automatically collected by the system over the Internet, thus eliminating the cost and delay associated with the traditional physical shipping of patient information. These modifications are then retrofitted onto the dataset used to generate the aligners. The aligners may then be physically fabricated.

Once the intermediate and final data sets have been created, the appliances may be fabricated. Common fabrication methods employ a rapid prototyping device such as a stereolithography machine. A particularly suitable rapid prototyping machine is Model SLA-250/50 available from 3D Systems, Valencia, Calif. The rapid prototyping machine selectively hardens a liquid or other non-hardened resin into a three-dimensional structure which can be separated from the remaining non-hardened resin, washed, and used either directly as the appliance or indirectly as a mold for producing the appliance. The prototyping machine receives the individual digital data sets and produces one structure corresponding to each of the desired appliances. Generally, because the rapid prototyping machine may utilize a resin having non-optimum mechanical properties and which may not be generally acceptable for patient use, the prototyping machine typically is used to produce molds which are, in effect, positive tooth models of each successive stage of the treatment. After the positive models are prepared, a conventional pressure or vacuum molding machine is used to produce the appliances from a more suitable material, such as 0.03 inch thermal forming dental material, available from Tru-Tain Plastics, Rochester, Minn. Suitable pressure molding equipment is available under the trade name BIOSTAR from Great Lakes Orthodontics, Ltd., Tonawanda, N.Y. The molding machine produces each of the appliances directly from the positive tooth model and the desired material. Suitable vacuum molding machines are available from Raintree Essix, Inc.

After production, the appliances can be supplied to the treating professional all at one time. The appliances are marked in some manner, typically by sequential numbering directly on the appliances or on tags, pouches, or other items which are affixed to or which enclose each appliance, to indicate their order of use. Optionally, written instructions may accompany the system which set forth that the patient is to wear the individual appliances in the order marked on the appliances or elsewhere in the packaging. Use of the appliances in such a manner will reposition the patient's teeth progressively toward the final tooth arrangement.

Because a patient's teeth may respond differently than originally expected, the treating clinician may wish to evaluate the patient's progress during the course of treatment. The system can also do this automatically, starting from anewly-measured in-course dentition. If the patient's teeth do not progress as planned, the clinician can revise the treatment plan as necessary to bring the patient's treatment back on course or to design an alternative treatment plan. The clinician may provide comments, oral or written, for use in revising the treatment plan. The clinician can also form another set of plaster castings of the patient's teeth for digital imaging and manipulation. The clinician may wish to limit initial aligner production to only a few aligners, delaying production on subsequent aligners until the patient's progress has been evaluated and alignment configuration can be more accurately estimated.

The invention has been described in terms of particular embodiments. Other embodiments are within the scope of the following claims. For example, the three-dimensional scanning techniques described above may be used to analyze material characteristics, such as shrinkage and expansion, of the materials that form the tooth castings and the aligners. Also, the 3D tooth models and the graphical interface described above may be used to assist clinicians that treat patients with conventional braces or other conventional orthodontic appliances, in which case the constraints applied to tooth movement would be modified accordingly.

1. A virtual health-care community, comprising:
a network to communicate information relating to the community;
one or more treatment consultants coupled to the network;
one or more treating professionals coupled to the network; and
a server coupled to the network, the server storing data for each patient and facilitating secured data sharing by the community.

2. The community of claim 1, wherein the treating professional views one or more of the following patient data visualization over the network: a right buccal view; a left buccal view; a posterior view; an anterior view; a mandibular occlusal view; a maxillary occlusal view; an overjet view; a left distal molar view; a left lingual view; a lingual incisor view; a right lingual view; a right distal molar view; an upper jaw view; and a lower jaw view.

3. The community of claim 1, wherein the treating professionals include dentists and orthodontists.

4. The community of claim 1, further comprising a first treating professional sharing a patient's information with a second authorized treating professional for consultation.

5. The community of claim 4, wherein the second authorized treating professional generates a treatment plan for approval by the first treating professional.

6. The community of claim 1, further comprising one or more partners coupled to the network, including one or more of the following: a financing partner, a supplier, and a delivery company.

7. The community of claim 1, wherein the supplier provides a plurality of appliances each having a geometry selected to progressively reposition the teeth from a first teeth arrangement to a second teeth arrangement.

8. The community of claim 7, wherein the supplier provides a proposed treatment plan and wherein a first treating professional engages a second treating professional to review or revise the proposed treatment plan.

9. The community of claim 7, wherein the first treating professional authorizes the supplier to manufacture the appliances after consulting with the second treating professional.

10. The community of claim 7, wherein the treating professionals rate each other on satisfaction.

11. A computer-implemented method for performing dental-related electronic commerce, comprising:
transmitting teeth data associated a patient from a dental server to a treating professional computer over the Internet upon an authorized request;
displaying a three-dimensional computer model of the teeth at the treating professional computer using a browser;
allowing a treating professional to manipulate the three-dimensional computer model of the teeth using the browser;
receiving a request from the treating professional to share the three-dimensional computer model with a consulting professional;
transmitting the computer model from the server to the consulting professional; and
generating an appliance to treat a patient based on the shared computer model of the teeth.

12. The method of claim 11, further comprising providing financing options for the patient using one or more financing partners.

13. The method of claim 11, further comprising offering an on-line shop geared to the patient's dental requirements.

14. The method of claim 11, further comprising providing office management utilities for the treating professional.

15. The method of claim 14, wherein the office management utilities include one or more of the following: patient scheduling, patient accounting, and claim processing.

16. The method of claim 11, wherein allowing a treating professional to manipulate the three-dimensional computer model of the teeth using the browser further comprises displaying a plurality of dental views.

17. The method of claim 16, wherein the dental views include one or more of the following: a right buccal view; a left buccal view; a posterior view; an anterior view; a mandibular occlusal view; a maxillary occlusal view; an overjet view; a left distal molar view; a left lingual view; a lingual incisor view; a right lingual view; a right distal molar view; an upper jaw view; and a lower jaw view

18. The method of claim 11, wherein allowing a treating professional to manipulate the three-dimensional computer model of the teeth using the browser further comprises clicking on a tooth to adjust its position.

19. The method of claim 18, further comprising displaying x, y and z axis to allow the treating professional to adjust the position of the tooth.

20. The method of claim 11, further comprising providing supplemental services to the patient, including teeth whitening services.

21. A server to support a health-care electronic commerce community with one or more service providers, comprising:
a processor adapted to communicate with a network;
a data storage device coupled to the processor and adapted to store data for each patient; and
software to communicate 3D patient data from a first service provider to a second service provider.

22. The server of claim 21, wherein the providers service one or more of the following health-care applications: dentistry applications, cosmetic augmentation, hair-care enhancements, liposuction, plastic or reconstructive surgery.
